(19) United States
(12) Patent Application Publication
(10) Pub. No.: US 2005/0223031 A1
(43) Pub. Date: Oct. 6, 2005

(54) Method and apparatus for retrieving visual object categories from a database containing images

(76) Inventors: Andrew Zisserman, Jericho (GB); Robert Fergus, New College (GB); Pietro Perona, Altadena (CA)

Correspondence Address: Richard S. Myers, Jr.;Stites & Harbison PLLC, Suite 1800, 424 Church Street, Nashville, TN, 37219-2376, US

(21) Appl. No.: 10/813,201

(22) Filed: Mar. 30, 2004

(51) Int. Cl. G06F 17/00

(52) U.S. Cl. 707/104.1

(57) ABSTRACT

A method and apparatus for determining the relevance of images retrieved from a database relative to a specified visual object category. The method comprises transforming a visual object category into a model defining features of the visual object category and a spatial relationship therebetween, storing the model, comparing a set of images identified during the database search with the stored model, calculating a likelihood value relating to each image based on its correspondence with the model, and ranking the images in order of the respective likelihood values. The apparatus comprises a processor for transforming a visual object category into a model defining features of the visual object category and a spatial relationship therebetween.

This invention relates to a method and apparatus for retrieving visual object categories from a database containing images and, more particularly, to an improved method and apparatus for searching for, and retrieving, relevant images corresponding to visual object categories specified by a user by means of, for example, an Internet search engine or the like.

It is relatively simple to conduct a search of the World Wide Web for images by simply entering one or more keywords into a search engine, in response to which, hundreds and sometimes thousands of related images may be returned in the search results for selection by the user. However, not all of the images returned in the results will be particularly relevant to the search. In fact, many of the images returned are likely to be completely unrelated.

In a text-based Internet search, the most relevant returned items (i.e. those containing precisely the keyword(s) entered, are identified and then ranked according to a numeric value based on the number of links existing to each respective web page in other web pages. As a result, the results likely to be of most relevance to the user are listed in the first few pages of the search results.

In the case of an image-based search, however, the results most likely to be of relevance are not likely to be returned in the first few pages of the search results, but instead are more likely to be evenly mixed with unrelated images. This is because current Internet image search technology is based on words, rather than image content, such that the images returned in the results contain the entered keyword(s) in either the filename of the image or text appearing near the image on a web page, and the results are then ranked as described above with reference to a text-based search. This method is highly effective in quickly gathering related images from the millions available across the World Wide Web, but the final outcome is far from perfect in the sense that the user may then have to go through tens or even hundreds or thousands of result entries to find the images of interest.

We have now devised an improved arrangement.

In accordance with the present invention, there is provided apparatus for determining the relevance of images retrieved from a database relative to a specified visual object category, the apparatus comprising means for transforming a visual object category into a model defining features of said visual object category and a spatial relationship therebetween.

Means may be provided for storing said model. In one exemplary embodiment of the invention, means are provided for comparing a set of images retrieved from a database with the stored model and calculating a likelihood value relating to each image based on its correspondence with said model. Means may further be provided for ranking the images in order of the respective likelihood values; and/or for retrieving further images corresponding to the specified visual object category.

Also in accordance with the present invention, there is provided a method for determining the relevance of images retrieved from a database relative to a specified visual object category, the method comprising transforming a visual object category into a model defining features of said visual object category and a spatial relationship therebetween. The method may further include the step of storing said model. In one exemplary embodiment of the invention, the method may further include the steps of comparing a set of images retrieved from the database with the stored model and calculating a likelihood value relating to each image based on its correspondence with the model. Preferably, the method includes ranking the images in order of the respective likelihood values; and/or for finding further images corresponding to the specified visual object category.

In any event, it will be appreciated that the set of images may be retrieved from a database during a search of that database, using for example, a search engine.

The features beneficially comprise at least two types, which categories may include pixel patches, curve segments, corners and texture. In a preferred embodiment, each part is represented by one or more of its appearance and/or geometry, its scale relative to the model, and its occlusion probability, which parameters may be modelled by probability density functions, such as Gaussian probability functions or the like.

The step of comparing an image with the models preferably includes identifying features of the image and evaluating the features using the above-mentioned probability densities.

The method may include the step of selecting a sub-set of the images retrieved during the database search, and creating the model from this sub-set of images. Alternatively, substantially all of the images retrieved during the database search may be used to create the model. In either case, at least two different models may be created in respect of a set of images retrieved during, for example, a database search, say patches and curves, although other features are envisaged. Alternatively, and more preferably, a heterogeneous model made up of a combination of features may be created. In any event, the method preferably includes the step of selecting the nature or type of model to be used for the comparison and ranking steps in respect of a particular set of images.

In one embodiment, the selective step may be performed by calculating a differential ranking measure in respect of each model, and selecting the model having the largest differential ranking measure.

These and other aspects of the present invention will be apparent from, and elucidated with reference to, the embodiments described herein.

Embodiments of the present invention will now be described by way of examples only and with reference to the accompanying drawings, in which:

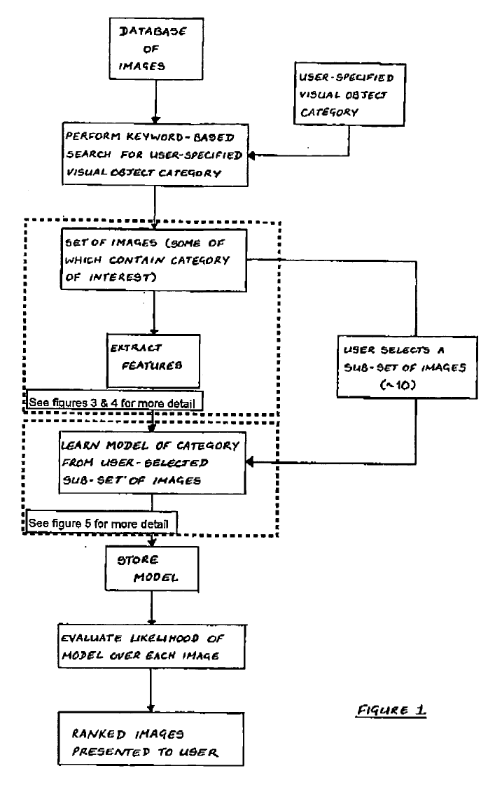

FIG. 1 is a schematic block diagram illustrating the principal steps of a method according to a first exemplary embodiment of the present invention;

FIG. 2 is a schematic block diagram illustrating the principal components of a method according to a second exemplary embodiment of the present invention.

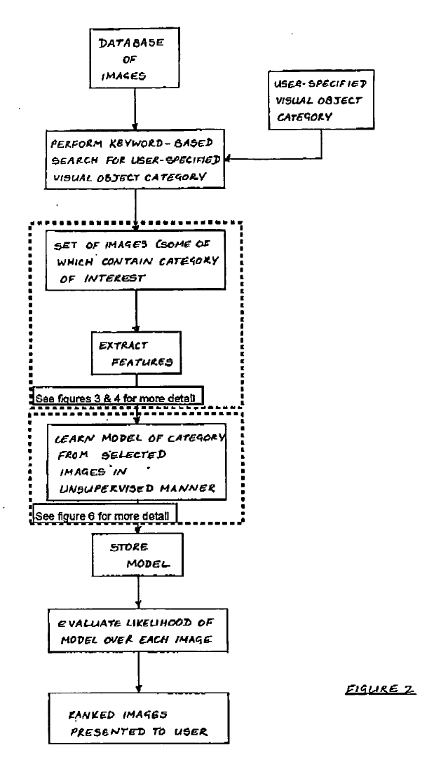

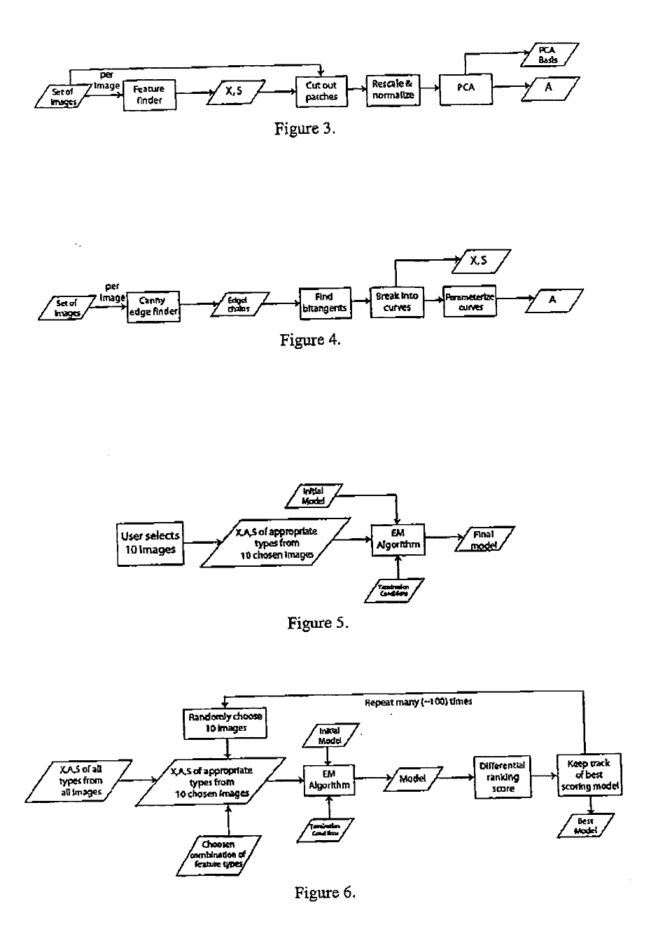

FIG. 3 is a schematic block diagram illustrating the principal steps of a patch feature extraction method for use in the method of FIG. 1 or FIG. 2;

FIG. 4 is a schematic block diagram illustrating the principal steps of a curve feature extraction method for use in a method of FIG. 1 or FIG. 2;

FIG. 5 is a schematic block diagram illustrating the principal steps of a model learning method in the supervised case used in the method of FIG. 1; and

FIG. 6 is a schematic block diagram illustrating the principal steps of a model learning method in the unsupervised case used in the method of FIG. 2 (note: a rectangle denotes a process while a parallelogram denotes data).

Thus, the present invention is based on the principle that, even without improving the performance of a search engine per se the above-mentioned problems related to image-based Internet searching may be alleviated by measuring ‘visual consistency’ amongst the images that are returned by the search and re-ranking them on the basis of this consistency, thereby increasing the proportion of relevant images returned to the user within the first few entries in the search results. This concept is based on the assumption that images related to the search requirements will typically be visually similar, while images that are unrelated to the search requirements will typically look different from each other as well.

The problem of how to measure ‘visual consistency’ is approached in the following exemplary embodiments of the present invention as one of probabilistic modelling and robust statistics. The algorithm employed therein robustly learns the common visual elements in a set of returned images so that the unwanted (non-category) images can be rejected, or at least so that the returned images can be ranked according to their resemblance to this commonality. More precisely, a visual object model is learned which can accommodate the intra-class variation in the requested category. It will be appreciated by a person skilled in the art that this is an extremely challenging visual task: not only are there visual difficulties in learning from images, such as lighting and viewpoint variations (scale, foreshortening) and partial occlusion, but the object may only actually be present in a sub-set of the returned images, and this sub-set (and ever its size) is unknown.

Referring to FIGS. 1 and 2 of the drawings, the apparatus and method of these exemplary embodiments of the invention employ an extension of a constellation model, and are designed to learn object categories from images containing clutter, thereby at least minimising the requirement for human intervention.

An object or constellation model consists of a number of parts which are spatially arranged over the object, wherein each part has an appearance and can be occluded or not. A part in this case may, for example, be a patch of picture elements (pixels) or a curve segment. In either case, a part is represented by its intrinsic description (appearance or geometry), its scale relative to the model, and its occlusion probability. The shape of the object (or overall model shape) is represented by the mutual position of the parts. The entire model is generative and probabilistic, in the sense that part description, scale model shape and occlusion are all modelled by probability density functions, which in this case are Gaussians.

The process of learning an object category is one of first detecting features with characteristic scales, and then estimating the parameters of the above densities from these features, such that the model gives a maximum-likelihood description of the training data.

In this exemplary embodiment, a model consists of P parts and is specified by parameters υ. Given N detected features with locations X, scales S, and descriptions D, the likelihood that an image contains an object is assumed to have the following form:

$$R = \frac{p ( X , S , D \vert θ )}{p ( X , S , D \vert {θ}_{bg} )}$$

Where the summation is over allocations, h, of parts to features. Typically, a model has 5-7 parts and there will be up to forty features in an image.

Similarly, it is assumed that non-object background images can be modelled by a likelihood of the same form with parameters υ_{bg}. The decision as to whether a particular image contains an object or not is determined by the likelihood ratio:

$$p ( X , S , D \vert θ ) = {\sum }_{h ∈ H} \underbrace{p ( D \vert h , θ )}_{PartDescription} \underbrace{p X \vert S , h , θ )}_{Shape} \underbrace{p ( S \vert h , θ )}_{Rel . Scale} \underbrace{p ( h \vert θ )}_{Other}$$

The model, at both the fitting and recognition stages, is scale invariant. Full details of this model and its fitting to training data using the EM algorithm are given by R. Fergus, P. Perona, and A. Zisserman in Object Class Recognition by Unsupervised Scale-Invariant Learning, In Proc. CVPR, 2003, and essentially the same representations and estimation methods are used in the following exemplary embodiments of the present invention.

Existing approaches to recognition learn a model based on a single type of feature, for example, image patches, texture regions or Harr wavelets, from which a model is learnt. However, the different visual nature of objects means that this approach is limiting. For some objects, say for example, wine bottles, the essence of the object is captured far better with geometric information (i.e. the outline) rather than by patches of pixels and, of course, the reverse is true for many objects, for example, human faces. Consequently, for a flexible visual recognition system, it is necessary to have multiple feature types. The flexible nature of the constellation model described above permits this in view of the fact that because the description densities of each part are independent, each can use a different type of feature.

In the following description, and referring to FIG. 3 of the drawings, only two types of features are considered, although more (e.g. corners, texture, etc.) can easily be added. The first of these types consists of regions of pixels, and the second consists of curve segments. It will be appreciated that these types of feature are complementary in the sense that the first represents the appearance of an object, whereas the other represents the object geometry.

An interest operator, such as that described by T. Kadir and M. Brady in Scale, Saliency and Image Description, IJCV, 45(2):83-105, 2001, may be used to find regions that are salient over both location and scale. It is based on measurements of the grey level histogram and entropy over the entire region. The operator detects a set of circular regions so that both position (the circle centre) and scale (the circle radius) are determined. The operator is largely invariant to scale changes and rotation of the image. Thus, for example, if the image is doubled in size, then the corresponding set of regions will be detected (at twice the scale).

In order to determine curve segments, rather than only considering very local spatial arrangements of edge points, extended edge chains may be used as detected, for example, by the edge operator described by J. F. Canny in A Computational Approach to Edge Detection, IEEE PAMI, 8(6):679-698, 1986. The chains are then segmented into segments between bitangent point, i.e. points at which a line has two points of tangency with the curve. This decomposition is used herein for two reasons. First, bitangency is covariant with projective transformations. This means that for near planar curves the segmentation is invariant to viewpoint, an important requirement if the same, or similar, objects are imaged at different scales and orientations. Second, by segmenting curves using a bi-local property, interesting segments can be found consistently despite imperfect edgel data. Bitangent points are found on each chain using the method described by C. Rothwell, A. Zisserman, D. Forsyth and J. Mundy in Planar Object Recognition Using Projective Shape Representation, IJCV, 16(2), 1995. Since each pair of bitangent points defines a curve which is a sub-section of the chain, there may be multiple decompositions of the chain into curved sections. In practice, many curve segments are straight lines (within a threshold for noise) and these are discarded as they are far less informative than curves. In addition, the entire chain is also used, thereby retaining convex curve portions.

Thus, the above-mentioned feature detectors result in the provision of patches and curves of interest within each image. In order to use them in the model of the present invention, it is necessary to parameterise their properties to for D=[A, G] where A is the appearance of the regions within the image and G is the shape of the curves within the image.

Once the regions are identified, they are cropped from the image and resealed to a smaller pixel patch. Each patch exists in a predetermined dimensional space. Since the appearance densities of the model must also exist in this space, it is necessary from a practical point-of-view to somehow reduce the dimensionality of each patch whilst retaining its distinctiveness. This is achieved in accordance with this exemplary embodiment of the invention using principal component analysis (PCA). In the learning stage, the patches from all images are collected and PCA performed on them. The appearance of each patch is then a vector of the coordinates within the first predetermined number k principal components, thereby giving A. This results in a good reconstruction of the original patch whilst using a moderate number of parameters per part.

Each curve is transformed to a canonical position using a similarity transformation such that it starts at the origin and ends at the point (1,0). If centroid of the curve is below the x-axis then it is flipped both in the x-axis and the line y=0.5, so that the same curve is obtained independent of the edgel ordering. The y value of the curve in this canonical position is sampled at, a number of equally spaced x intervals between (0,0) and (1,0). Since the model is not orientation-invariant, the original orientation of the curve is concatenated to a vector for each curve, giving another vector. Combining the vectors from all curves within the images gives G.

In the following, the exemplary implementation of the gathering of images, and the main steps in applying the above-described algorithm (namely, feature detection, model learning and ranking) will be described in more detail.

For a given keyword, an image search using a search engine such as Google® may be used to download a set of images and the integrity of the downloaded images is checked. In addition, those outside a reasonable size range, say between 100 and 600 pixels on the major axis) are discarded. A typical image search is likely to return in the region of 450-700 usable images and a script may be employed to automate the procedure. To evaluate the algorithms, the images returned can be divided into three distinct types:
Good images, i.e. good examples of the keyword category, lacking major occlusion, although there may be a variety of viewpoints, scalings and orientations.
Intermediate images, i.e. those images which are in some way related to the keyword category, but are of lower quality than the good images; they may have extensive occlusion, substantial image noise, be a caricature or cartoon of the category, or the category may be rather insignificant in the overall image, or there may be some other fault.
Junk images, i.e. those images which are totally unrelated to the keyword category.

In this particular case, each image is converted into greyscale (because colour information is not used in the model described above, although colour information may be used in other models applied to embodiments of the present invention, and the invention is not intended to be limited in this regard), and curves and regions of interest are identified within the images. This produces X, D and S for use in learning or recognition A predetermined number of regions with the highest saliency are used from each image.

The learning process takes one of two distinct forms: unsupervised learning (FIG. 6) and limited supervision (FIG. 5). In unsupervised learning, a model is learnt using all images in a dataset. No human intervention is required in the process. In learning with limited supervision, an alternative approach using relevance feedback is used, whereby a user selects, say, 10 or so images from the dataset that are close to the required image, and a model is learnt using these selected images.

In both approaches, the learning task takes the form of estimating the parameters θ of the model discussed above. The goal is to find the parameters θ_{ML} which best explain the data X, D, S from the chosen training images (be it 10 or the whole dataset), i.e. maximise the likelihood

$${θ}_{ML} = {arg max}_{θ} p ( X , D , S \vert θ ) .$$

The model is learnt using the EM algorithm as described by R. Fergus et al in the reference specified above.

Given the learnt model, all hypotheses within a particular image are evaluated, and this determines the likelihood ratio for that image. This likelihood ratio is then used to rank all the images in the dataset.

For each set of images, a variety of models may be learned, each made up of a variety of feature types (e.g. patches, curves, etc), and a decision must then be made as to which should give the final ranking that will be presented to a user. In accordance with an exemplary embodiment of the present invention, this is done by using a second set of images, consisting entirely of “junk” images (i.e. images which are totally unrelated to the specified visual object category). These may be collected by, for example, typing “things” into a search engine's image search facility. Thus, there are now two sets of images, or datasets: a) the one to be ranked (consisting of a mixture of junk and good images) and b) the junk dataset. In accordance with this exemplary embodiment of the invention, each model evaluates the likelihood of images from both datasets and a differential ranking measure is computed between them, for example, by looking at the area under an ROC curve between the two data sets. The model which gives the largest differential ranking measure is selected to give the final ranking presented to the user.

The rationale behind this exemplary approach is as follows. It can be assumed that the statistics of the junk images in the junk dataset b) are the same as those of the junk images in dataset a) to be ranked, such that by looking at a differential ranking measure, the contributions of the junk images in both datasets cancel, giving a measure of the good images alone. The higher their ranking, the better the model should be.

The model fitting situation dealt with herein is equivalent to that faced in the area of robust statistics: in the sense that there is an attempt to learn a model from a dataset which contains valid data (the good images) but also outliers (the intermediate and junk images) which cannot be fitted by the model. Consequently, a robust fitting algorithm, RANSAC may be adapted to the needs of the present invention A set of images sufficient to train a model (10, in this case) is randomly sampled from the images retrieved during a database search. This model is then scored on the remaining images by the differential ranking measure explained above. The sampling process is repeated a sufficient number of times to ensure a good chance of a sample set consisting entirely of inliers (good images).

The models of a category have been shown to be capable of being learnt from training sets containing large amounts of unrelated images (say up to 50% and beyond) and it is this ability that allows the present invention to handle the type of datasets returned by conventional Internet search engines. Further, in the present invention, as described above with respect to the two exemplary embodiments, the algorithm only requires images as its input, so the method and apparatus of the present invention can be used in conjunction with any existing search engine. Still further, it will be appreciated by a person skilled in the art that the present invention has as a significant advantage that it is scale invariant in its ability to retrieve/rank relevant images.

Two specific exemplary embodiments of the invention have been described: in the first, a user is required to spend a limited amount of time (say 20-30 seconds) selecting a small proportion of images of which they require examples (i.e. a simple form of relevance feedback or supervised learning) as illustrated in FIG. 1; in the second, there is no requirement for user intervention in the learning (i.e. it is completely unsupervised), as illustrated in FIG. 2.

The speed of the algorithm is of great practical importance: web-usage studies show that users are prepared to wait only a few seconds for a web-page to load. The timings given below are for a 30 GHz machine.

In the case of the Internet search engine application, a large set of category keywords can be automatically obtained by choosing the most commonly searched for image categories (information that existing search engines can easily compile).

In the unsupervised learning case, everything can be pre-computed off-line, since no user input is required, for this set of category keywords. Therefore there is no time penalty for the algorithm. Although the off-line computation may take some time (perhaps even several days depending on the number of models learnt in the RANSAC approach) it only needs to be done once.

In the supervised learning case the situation is harder. Once the user has selected a few images, several models (corresponding to different combinations of feature types) must be learnt and then those models must be run over the entire dataset (˜1000 images) all within a few seconds. To make this possible the following measures are undertaken:
(i) extract features from all images in dataset off-line and store them. This only needs to be done once,
(ii) learn the different models in parallel;
(iii) run the different models over the entire dataset in parallel.

These measures mean that the speed bottlenecks are dependent on how quickly a model can be learnt and how quickly it can be used to evaluate an image. With the current non-optimized development implementation, the whole process takes around a minute, but with professional grade coding and optimisation this can be reduced to a few seconds.

Again, the choice of category keyword (needed for (i) above) can be automatically selected by choosing the most commonly searched for categories.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method for determining the relevance of images retrieved from a database relative to a specified visual object category, the method comprising transforming a visual object category into a model defining features of said visual object category and a spatial relationship therebetween, storing said model, comparing a set of images identified during said database search with said stored model and calculating a likelihood value relating to each image based on its correspondence with said model, and ranking said images in order of said respective likelihood values.

2. A method according to claim 1, wherein the step of comparing an image with said model includes identifying features of the image and estimating the probability densities of said parameters of those features to determine a maximum likelihood description of said image.

3. A method according to claim 2 further comprising storing said model.

4. A method according to claim 3 further comprising comparing a set of images retrieved from said database with said stored model and calculating a likelihood value relating to each image based on its correspondence with said model.

5. A method according to claim 4, further comprising ranking said images in order of said respective likelihood values; and/or retrieving further images corresponding to said specified visual object category.

6. A method according to claim 1, wherein said features comprise at least two types of parts of an object.

7. A method according to claim 6, wherein said categories include pixel patches, curve segments, corners and texture.

8. A method according to claim 1, wherein each feature is represented by one or more parameters, which parameters include its appearance and/or geometry, its scale relative to the model, and its occlusion probability.

9. A method according to claim 8, wherein said parameters are modelled by probability density functions.

10. A method according to claim 9, wherein said probability density functions comprise Gaussian probability functions.

11. A method according to claim 1, wherein said set of images is obtained during a database search.

12. A method according to claim 1, further comprising selecting a sub-set of said set of images, and creating the model from said sub-set of images.

13. A method according to claim 2, wherein substantially all of the images of said set of images are used to create the model.

14. A method according to claim 2, wherein at least two different models are created in respect of a set of images retrieved from said database.

15. A method according to claim 14, further including selecting one of said at least two models for said comparing step.

16. A method according to claim 15, wherein said selecting step is performed by calculating a differential ranking measure in respect of each model, and selecting the model having the largest differential ranking measure.

17. Apparatus for determining the relevance of images retrieved from a database relative to a specified visual object category, the apparatus comprising a processor for transforming a visual object category into a model defining features of said visual object category and a spatial relationship therebetween.

18. Apparatus for ranking, according to relevance, images of a set of images retrieved from a database relative to a specified visual object category, the being arranged and configured to a visual object category into a model defining features of said visual object category and a spatial relationship therebetween, store said model, compare a set of images identified during said database search with said stored model and calculate a likelihood value relating to each image based on its correspondence with said model, and to said images in order of said respective likelihood values.
